(19) United States
(12) Patent Application Publication
(10) Pub. No.: US 2020/0185998 A1
(43) Pub. Date: Jun. 11, 2020

(54) STATOR UNIT AND FAN MOTOR

(71) Applicant: NIDEC CORPORATION, Kyoto (JP)

(72) Inventors: Yuta YAMASAKI, Kyoto (JP); Hideki AOI, Kyoto (JP)

(73) Assignee: NIDEC CORPORATION, Kyoto (JP)

(21) Appl. No.: 16/703,863

(22) Filed: Dec. 5, 2019

(30) Foreign Application Priority Data
Dec. 10, 2018 (CN) 201822058563.2

(51) Int. Cl. H02K 5/10; H02K 7/14; F04D 29/38

(52) U.S. Cl. CPC H02K 5/10; F04D 29/388; H02K 7/14

(57) ABSTRACT

A stator unit supporting a rotor rotatable about a central axis and a fan motor are disclosed. The stator unit includes a stator and a stator cap including a fixing part fixed to the stator and a cover covering at least a portion of the stator. The fixing part includes a first fixing part extending downward in an axial direction.

### CROSS-REFERENCE TO RELATED APPLICATION

This application claims the priority of China patent application serial no. 201822058563.2, filed on Dec. 10, 2018. The entirety of the above-mentioned patent application is hereby incorporated by reference herein and made a part of this specification.

### BACKGROUND

### Technical Field

The disclosure relates to the technical field of electromechanical devices, and in particular, to a stator unit and a fan motor.

### Description of Related Art

In order to improve dust-proof and water-proof performance of a stator, a stator cap for covering the stator is provided, and the stator cap is fixed to an outer wall of a housing.

It should be noted that the introduction in Background is merely provided for the convenience of clearly and comprehensively describing the technical solutions of the disclosure and facilitating the understanding of those skilled in the art. These technical solutions shall not be deemed well-known by those skilled in the art simply for having been described in Background.

However, according to above conventional technology, although the stator cap can cover the outer side surface of the outer wall and is fixed through riveting or snap-fit connection, ventilation may be obstructed as a result of an increased outer diameter of the outer wall.

### SUMMARY

According to an aspect of the disclosure, a stator unit is provided. The stator unit supports a rotor rotatable about a central axis, and includes a stator. The stator unit further includes a stator cap including a fixing part fixed to the stator and a cover covering at least a part of the stator. The fixing part includes a first fixing part extending downward in an axial direction. The fixing part includes a first fixing part extending downward in an axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a view illustrating the structure of a blower in the conventional art.

FIG. 2 is a view illustrating the structure of a fan motor having a stator unit according to Embodiment 1 of the disclosure.

FIG. 3 is an enlarged view at a location A shown in FIG. 2.

FIG. 4 is a view illustrating the structure of a fan motor having a stator unit according to Embodiment 2 of the disclosure.

FIG. 5 is an enlarged view at a location B shown in FIG. 4.

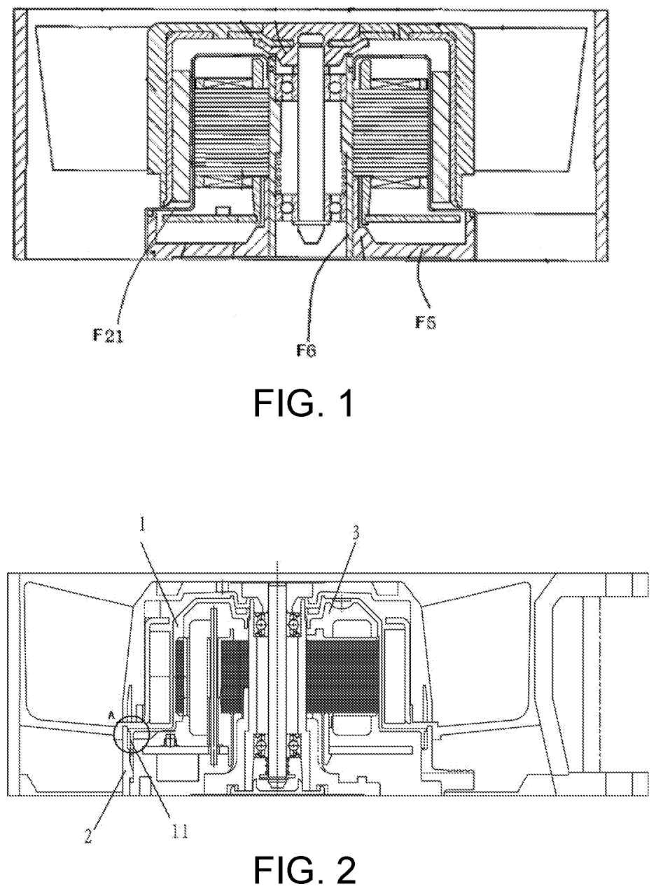

### DESCRIPTION OF THE EMBODIMENTS

The foregoing and other features of the disclosure will become apparent from the following specification with reference to the accompanying drawings. Specific embodiments of the disclosure are disclosed in the specification and the accompanying drawings. The specification and the accompanying drawings describe several embodiments to which the principles of the disclosure are applicable. However, it should be understood that, the disclosure is not limited to the embodiments described herein, but shall include all modifications, variations and equivalents falling within the scope of the appended claims.

A stator unit and a fan motor according to the embodiments of the disclosure are described in the following with reference to the accompanying drawings.

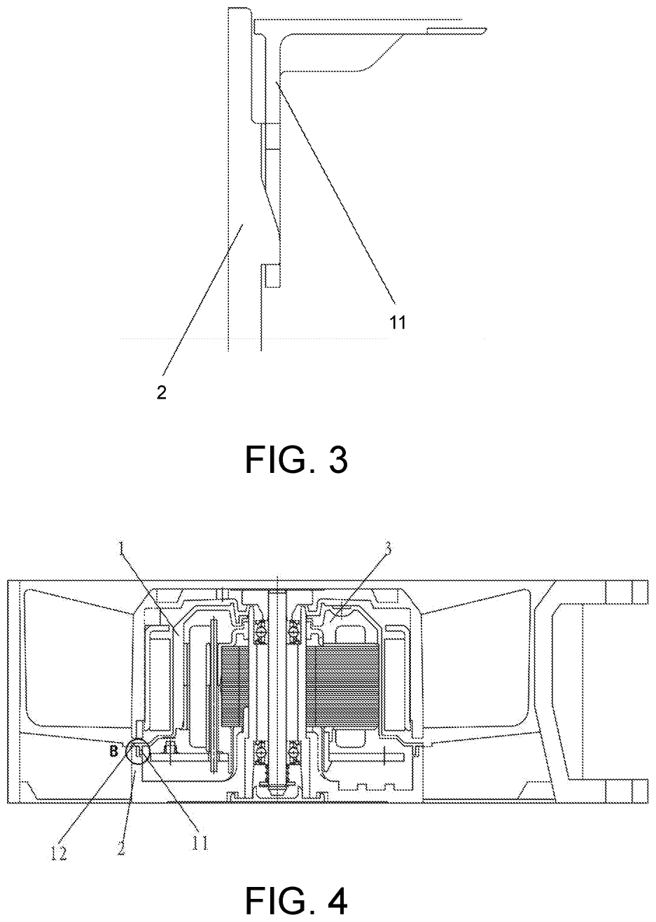

Referring to FIG. 2 and FIG. 3, FIG. 2 is a view illustrating the structure of a fan motor having a stator unit according to Embodiment 1 of the disclosure, and FIG. 3 is an enlarged view at a location A shown in FIG. 2. The fan motor of the embodiment includes an impeller, a stator unit, and a rotor supported by the stator unit to rotate about a central axis.

The stator unit includes a stator and a stator cap 1 including a fixing part fixed to the stator and a cover covering at least a portion of the stator. The fixing part includes a first fixing part 11 extending downward in an axial direction. An outer wall 2 extending upward in the axial direction is disposed at an axially lower part of the stator. In a radial direction, an inner diameter side of the outer wall 2 is opposite to an outer diameter side of the first fixing part 11 at an axially lower end part of the stator cap 1. The stator cap 1 is fixed to the outer wall 2 at a location closer to the inner side than an outer side surface of the outer wall 2, so as to facilitate fan performance as well as dust-proof and water-proof performance.

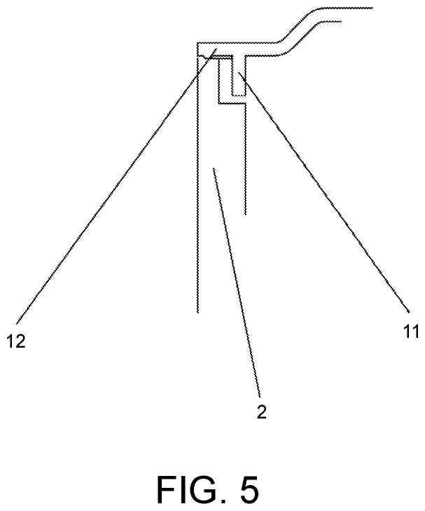

Referring to FIG. 4 and FIG. 5, FIG. 4 is a view illustrating the structure of a fan motor having a stator unit according to Embodiment 2 of the disclosure, and FIG. 5 is an enlarged view at a location B shown in FIG. 4.

The fan motor provided in Embodiment 2 is based on Embodiment 1. An upper part of the outer wall 2 is fixed to a second fixing part 12 extending upward in the axial direction or outward in the radial direction from a base of the first fixing part 11.

At the fixing part, the stator cap 1 and the stator are fit and bonded to each other by an adhesive or welded to each other.

In the case of bonding, curing may take a certain amount of time, and gas may be generated. A UV-curing adhesive is selected as the adhesive. The UV-curing adhesive takes a short period of time to cure, and only generates little gas that affects a filling agent. For a delayed UV-curing adhesive, there are processes such as applying the adhesive, irradiating with UV, and tightly attaching.

The welding may be thermal welding or laser welding. Thermal welding takes a short period of time and is easy to realize. Compared with processes using a chemical agent, thermal welding does not generate gas.

In addition to choosing the adhesive, bonding processes also include operational processes such as treating the bonding surface, applying an appropriate amount, tightly attaching, and maintaining until cured. In particular, depending on the choice on the adhesive, the details of the operational processes may vary. In the embodiment, the shape of the first fixing part 11 opposite to an inner side surface of the outer wall 2 and extending downward and the shape of the second fixing part 12 opposite to an upper surface of the outer wall 2 and extending outward in the radial direction are compatible with the operational processes.

As for welding, in addition to choosing the welding method and the required equipment, welding also includes operational processes such as treating a welding surface, and maintaining until cured. Compared to bonding, although welding requires equipment, the operational processes are fewer.

Further, a resin part 3 is provided on an inner side of the stator cap 1 to prevent a filling agent from leaking through the fixing part when the filling agent is filled inside.

The embodiments of the disclosure are described in detail with reference to the accompanying drawings, which illustrate the examples to which the principles of the disclosure are applicable. It should be understood that the embodiments of the disclosure are not limited to those described above, but shall cover all variations, modifications, and equivalents within the scope of the disclosure.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator unit, supporting a rotor rotatable about a central axis and comprising:
a stator,
wherein the stator unit further comprises a stator cap comprising a fixing part fixed to the stator and a cover covering at least a portion of the stator, and
the fixing part comprises a first fixing part extending downward in an axial direction.

2. The stator unit according to claim 1, wherein an outer wall extending upward in the axial direction is disposed at an axially lower part of the stator, and, in a radial direction, an inner diameter side of the outer wall is opposite to an outer diameter side of the first fixing part at an axially lower end part of the stator cap.

3. The stator unit according to claim 2, wherein an upper part of the outer wall is fixed to a second fixing part extending upward in the axial direction or outward in the radial direction from a base of the first fixing part.

4. The stator unit according to claims 1, wherein at the fixing part, the stator cap and the stator are bonded to each other by an adhesive.

5. The stator unit according to claim 4, wherein the adhesive is a UV-curing adhesive.

6. The stator unit according to claim 1, wherein at the fixing part, the stator cap and the stator are welded to each other.

7. The stator unit according to claim 6, wherein the welding is thermal welding.

8. The stator unit according to claim 6, wherein the welding is laser welding.

9. The stator unit according to claim 1, wherein a resin part is provided on an inner side of the stator cap.

10. A fan motor, comprising a rotor and an impeller, wherein the fan motor further comprises the stator unit according to claim 1.
